(19) United States
(12) Patent Application Publication
(10) Pub. No.: US 2014/0122618 A1
(43) Pub. Date: May 1, 2014

(54) USER-AIDED LEARNING CHATBOT SYSTEM AND METHOD

(71) Applicant: Xiaojiang Duan, Chaoyang District (CN)

(72) Inventor: Xiaojiang Duan, Chaoyang District (CN)

(21) Appl. No.: 13/661,034

(22) Filed: Oct. 26, 2012

(51) Int. Cl. G06F 15/16

(52) U.S. Cl. 709/206

(57) ABSTRACT

A user-aided learning chatbot system and method. The chatbot includes an interactive dialog interface for engaging in a chat session with a user. The user can enter knowledge entries during the chat session without losing context. The chatbot enters and stores the knowledge entry for interaction with subsequent users.

### CROSS-REFERENCE TO RELATED APPLICATIONS

This application is related to the following U.S. non-provisional patent applications: U.S. patent application Ser. No. ______, entitled “Chatbot System and Method with Contextual Input and Output Messages” filed herewith (Attorney Docket No. ACOSYS.003US); U.S. patent application Ser. No. ______, entitled “Chatbot System and Method with Enhanced User Communication” filed herewith (Attorney Docket No. ACOSYS.004US); U.S. patent application Ser. No. ______, entitled “Chatbot System and Method with Interactive Chat Log” filed herewith (Attorney Docket No. ACOSYS.005US); U.S. patent application Ser. No. ______, entitled “Chabot System and Method Having Auto-Select Input Message with Quality Response” filed herewith (Attorney Docket No. ACOSYS.006US); all of which are hereby incorporated by reference in their entirety as if fully set forth in the present invention for all purposes.

### COMPUTER PROGRAM LISTING APPENDIX

A computer program listing appendix is provided via EFS with this application. The information is hereby incorporated by reference as if set forth in full in this application for all purposes. A portion of the disclosure recited in this application contains material which is subject to copyright protection. Specifically, the computer program listing appendix and possibly other portions of the application may recite or contain source code, data or other functional text. The copyright owner has no objection to the facsimile reproduction of the functional text; otherwise all copyright rights are reserved.

### BACKGROUND OF THE INVENTION

The present invention relates generally to chatbot systems and methods, and more specifically to user-aided learning chatbot systems and methods.

Many businesses do not typically provide live chat customer support or service operators to assist their Internet customers. In such cases, an automated chatbot might be used to communicate with customers.

The chatbot is a computer program designed to simulate an intelligent conversation with one or more human users via auditory or textual methods. Chatbots are often integrated into interactive dialogs for various practical purposes such as personalized service, or information acquisition.

An interactive dialog, known as a chat session, begins between a user and the chatbot. The chat session allows the user to receive answers to inquiries and receive information from the chatbot. The answers that the user receives from the chatbot are often preprogrammed into the chatbot.

It is within the above context that a need for the present invention has arisen. There is, thus, a need to address one or more of the foregoing disadvantages of conventional systems and methods, and the present invention meets this need.

### BRIEF SUMMARY OF THE INVENTION

Various aspects of a user-aided learning chatbot method and system can be found in exemplary embodiments of the present invention.

In a first embodiment, the user-aided chatbot system and method adds user entries to a knowledge database of the chatbot. The method begins by initiating a chat session when an input message is received from a user via an interactive dialog interface that is responsive to the input message. Next, the interactive dialog interface displays a chatbot message as an output of the chatbot, wherein the input message and the chatbot message are a paired entry in a knowledge database. The chatbot message may also be created based on a set of rules and/or several paired entry in the knowledge database.

In some embodiments, the user trains the chatbot by replacing the chatbot message with a user-generated message that is entered via the interactive dialog interface. The user-generated message is preceded and/or followed by a predetermined unique identifier, such as angled brackets, an asterisk, etc., the unique identifier instructing the chatbot to replace the chatbot message with the user-generated message.

Consequently, the knowledge database is modified to replace the chatbot message with the user-generated message so that the input message and the user-generated message are a paired entry. The knowledge database may also be modified to add the user-generated message as a new entry where the chatbot message is created based on a set of rules or multiple paired entries. Thereafter, the chat session can resume without losing the context of the conversation. In this manner, new chatbot messages can be repetitively modified with a plurality of user-generated messages while maintaining conversational context.

A further understanding of the nature and advantages of the present invention herein may be realized by reference to the remaining portions of the specifications and the attached drawings. Further features and advantages of the present invention as well as the structure and operation of various embodiments of the present invention are described in detail below with respect to the accompanying drawings. In the drawings, the same reference numbers indicate identical or functionally similar elements.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a user-aided learning chatbot system according to an embodiment of the present invention;

FIG. 2 illustrates an interactive dialog interface in accordance with an exemplary embodiment of the present invention;

FIG. 3 illustrates a chatbot training session in accordance with an embodiment of the present invention;

FIG. 4 illustrates exemplary embedded installation code in accordance with an embodiment of the present invention;

FIG. 5 illustrates a user-aided learning chatbot method in accordance with an exemplary embodiment of the present invention;

FIG. 6A shows a typical computer system; and

FIG. 6B shows subsystems of the computer of FIG. 6A.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail so as to not unnecessarily obscure aspects of the present invention.

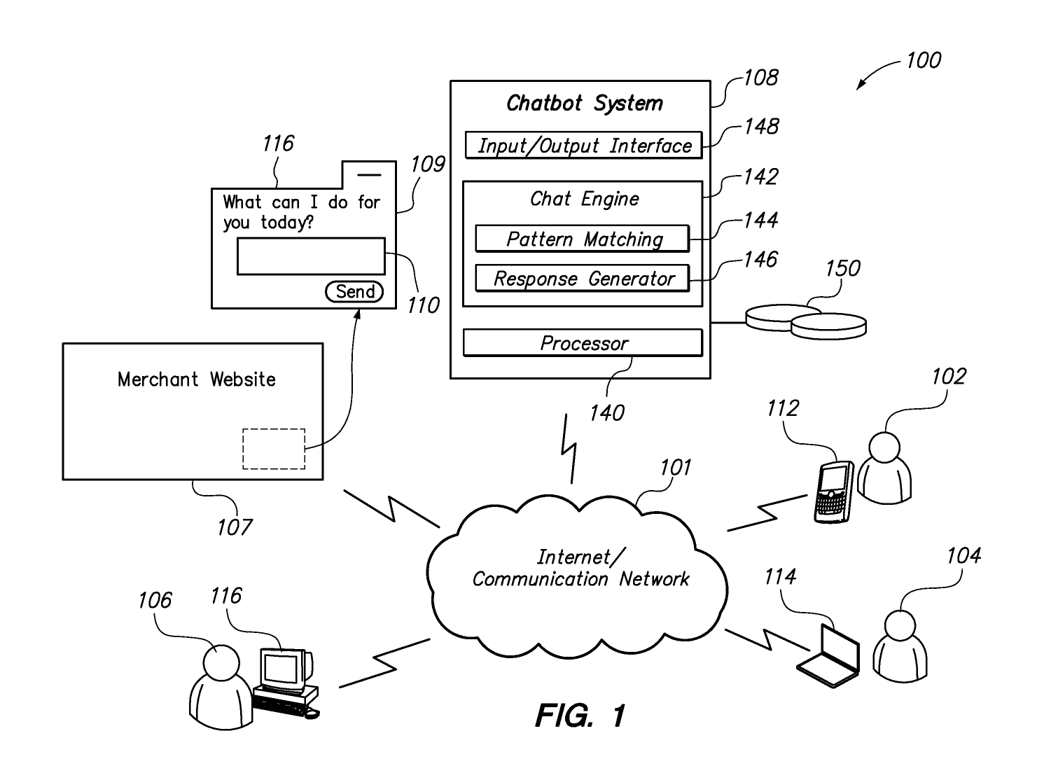

FIG. 1 illustrates chatbot communication system 100 according to an exemplary embodiment of the present invention.

In FIG. 1, chatbot communication system 100 comprises user 102 communicably coupled to chatbot system 108 via Internet 101. User 102 represents a customer visiting a website over Internet 101, and commencing a chat session with chatbot system 108.

Internet 101 represents any distributed network (wired, wireless or otherwise) for data transmission and receipt between/among two or more points. In some embodiments, chatbot system 108 includes a graphical image, including, without limitation, an avatar, a talking head, a text-to-speech engine, etc. Although not shown, chatbot system 108 might be installed on a stand-alone computer without need for a computer network.

As shown in FIG. 1, user 102 utilizes mobile device 112 to communicate with chatbot system 108. Mobile device 112 is a portable communication device such as a smart phone and the like. In one embodiment, the communication with chatbot system 108 can occur when user 102 is visiting one or more websites such as merchant website 107 that has chatbot dialog interface 116 of chatbot system 108 preinstalled on the website as further discussed below. User 102 essentially uses a browser (not shown) and chatbot dialog interface 116 to interact with chatbot system 108.

In FIG. 1, user 104 represents an additional customer. Many customers can concurrently communicate with chatbot system 108. Here, user 104 utilizes laptop computing device 114 for communicating with chatbot system 108 in a manner akin to user 102. For example, user 104 visiting merchant website 107 can also communicate with chatbot system 108 via chatbot dialog interface 116.

In FIG. 1, merchant 106 represents a merchant that operates merchant website 107. Merchant 106 installs chatbot dialog interface 116 of chatbot system 108 on its merchant website 107. Chatbot dialog interface 116 is a client extension of chatbot system 108. Thus, users can communicate with chatbot system 108 via chatbot dialog interface 116. Consequently, users visiting merchant website 107 can learn about products and/or services offered by merchant 106 by communicating with chatbot system 108 via chatbot dialog interface 116.

Here, merchant 106 provides initial training for chatbot system 108 by using a browser (not shown) on desktop computing device 115. Specifically, merchant 106 uses the browser to access and display chatbot dialog interface 116 to communicate with chatbot system 108. In essence, merchant 106 provides the message and theme for chatbot system 108 while users 102, 104 are the corresponding consumers.

Merchant 106 can train chatbot system 108 by entering input messages into dialog box 110 of chatbot dialog interface 116. Chatbot system 108 responds to an input message by displaying an output message via output display 109 above dialog box 110. As shown, an output message “What can I do for you today?” is displayed by output display 109. Note that this is a special output message, called an initial or opening message. Its corresponding “input message” is the user's action of browsing to a web page.

Chatbot messages are generated by chatbot system 108 by querying the input message from users in a knowledge base according to a certain set of rules. Merchant 106 trains chatbot system 108 to provide modified messages for a chat session by replacing chatbot system 108's initial chatbot messages with user-generated messages.

Chatbot system 108 includes a graphical image representing chatbot dialog interface 116, the graphical image including, without limitation, an avatar, a talking head, a text-to-speech engine, etc. In some embodiments, users 102, 104, 106 enter input messages to chatbot system 108 with a keyboard, mouse, and a visual recognition device.

The back and forth interaction between chatbot system 108 and users 102, 104 and 106 via chatbot dialog interface 116 allows knowledge database 150 to store and process myriad combinations of user-generated messages as context for additional future chatbot messages.

In FIG. 1, chatbot system 108 includes input/output interface 148 for entering and displaying messages to and from users 102, 104, 106. Chatbot system 108 also includes chat engine 142 that receives an input message from dialog box 110 and processes the input message by pairing or associating the input message with an appropriate chatbot message.

As shown in the embodiment of FIG. 1, chat engine 142 utilizes pattern matching engine 144 to recognize appropriate responses for input messages. In one embodiment, pattern matching engine 144 employs AIML (Artificial Intelligence Markup Language), which is an XML dialect for creating natural software agents. AIML comprises several elements. A first is category, which is a fundamental unit of knowledge. A category includes two or more elements namely pattern and template.
<category>
   <pattern>WHAT IS YOUR NAME</pattern>
   <template>My name is Eddy.</template>
</category>

When this category is loaded, an AIML receiving an input “What is your name” can respond with “My name is Eddy.” Here, a pattern is a string of characters that can match one or more user inputs. A pattern such as “What is your name” matches only one input, whether upper or lower case. However, patterns can also contain wildcards; thus, “what is your *” can match many inputs such as “what is your objective,” what is your address,” etc.

A template provides the response for a pattern. An example of a template is—My name is Eddy. A template can also use variables. A template may be as simple as some literal text, like “My name is <chatbot name=”name“/>,” which substitutes the chatbot's name into the sentence, or “You said you are <get name=”user-age“/>years of age,” in which the user's age is replaced in the sentence.

Text formatting, conditional response (if then/else), and random responses are elements of templates. Templates can also use the srai element to redirect to other pattern. As in this example where CDATA is used to avoid the need for XML escaping, synonymy may be implemented.

```
<category>
  <pattern>WHAT IS YOUR NAME</pattern>
  <template><![CDATA[My name is <chatbot
name=“name”/>.]]></template>
</category>
<category>
  <pattern>WHAT ARE YOU CALLED</pattern>
  <template>
  <srai>what is your name</srai>
  </template>
</category>
```

In the first category, the input “what is your name” receives the chatbot's name as a response. In the second category, the input “what are you called” is redirected to the category that matches the input “what is your name.” In essence, the two phrases are equivalent. Templates may include other content types that are processed by the chatbot user interface. As an example, a template may employ HTML tags for formatting. Clients not supporting HTML typically ignore the tag.

Those skilled in the art will recognize that other techniques that can either substitute or supplement pattern matching engine 144 can be employed. Pattern matching engine 144 then passes the chatbot message to response generator 146, which generates an appropriate response.

In FIG. 1, in one embodiment, knowledge database 150 may receive and store input messages 210 and user-generated messages including the context for such user-generated messages. The messages are received via chatbot dialog interfaces 116 displayed on mobile device 112, laptop computing device 114 or desktop computing device 115. Many components of chatbot system 108 have been omitted to avoid unnecessarily complicating the description of the invention. One skilled in the art will realize that chatbot system 108 may comprise more or less components as needed to implement the present invention.

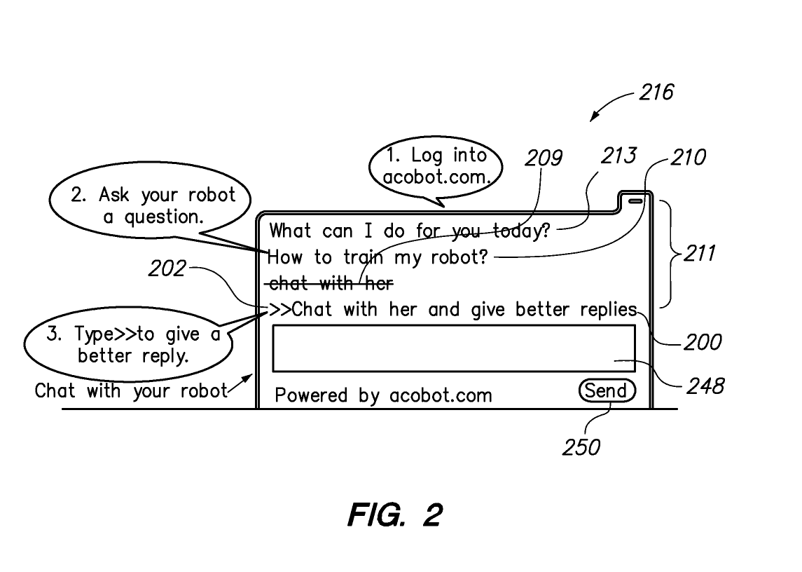

User-generated messages provide a context for subsequent chatbot messages of chatbot system 108, and for subsequent user input messages. In this manner, a new chatbot message is repetitively modified both prior to and during a chat session by entering a plurality of user-generated messages and training chatbot system 108 by preceding and/or following user-generated messages with unique identifiers (e.g., 202 of FIG. 2).

Briefly, in operation, merchant 106 trains chatbot system 108 to provide modified chatbot messages that are displayed by output display 109 of chatbot dialog interface 116. Merchant 106 utilizes merchant website 107 to install and utilize chatbot system 108. Merchant website 107 can provides a plethora of information to numerous customers simultaneously. Merchant website 107 operatively couples to Internet 101 via local network line 128.

Merchant 106 trains chatbot system 108 to provide modified chatbot messages 109 during a chat session. Thus, for example, merchant 106 might wish to teach chatbot system 108 to respond to address inquiries received from users of merchant website 107. User/merchant 106 begins by entering “Where are your offices?” into chatbot dialog interface 116.

In response, chatbot system 108 might generate a response such as “Please check our website, thank you.” Merchant 106 being dissatisfied with this message may wish to replace this chatbot response with the merchant's business address. Generally, merchant 106 can then enter “100 Main Street” into chatbot dialog interface 116. Thereafter, when the customer enters an input message “Where is your business located?,” chatbot system 108 replies, “100 Main Street”. Those skilled in the art will recognize that user-generated message (provided by merchant 106) is more robust and descriptive than the initial chatbot message.

FIG. 2 illustrates chatbot dialog interface 216 of chatbot system 108 (FIG. 1) in accordance with an exemplary embodiment of the present invention.

In FIG. 2, chatbot dialog interface 216 includes a visual graphic that encompasses two main areas namely dialog box 248 and output display 211. User input messages entered via dialog box 248 are displayed in output display 211. Chatbot response messages generated by chatbot system 108 are also displayed by output display 211.

Once chatbot system 108 is initialized, chatbot dialog interface 216 is displayed and is ready to initiate a chat session. Specifically, upon initiation, chatbot system 108 displays a prompt message “What can I do for you today?” 213 that prompts user 102 for an input message. “What can I do for you today?” 213 is a special output message, called an initial or opening message.

Responsive to prompt message “What can I do for you today?” 213, the user (e.g. merchant 106) enters an input message “How to train my robot?” 210 into dialog box 248 and then clicks send button 250. Chatbot system 108 responds by displaying output message “Chat with her” 209. Here, merchant 106 is dissatisfied with this message and wishes to train chatbot system 108 to display a modified message from the user.

Merchant 106 then enters user-generated message “Chat with her and give better replies” 200 into dialog box 248. This user-generated message 200 is preceded by a predetermined unique identifier such as the double angle brackets “>>” 202. Alternatively or in addition, the user-generated message 200 may be followed by the predetermined unique identifier. Those skilled in the art will realize that other identifier types e.g., asterisk, etc. can by utilized consistent with the spirit and scope of the present invention.

Predetermined unique identifier 202 directs chatbot system 108 to replace output message “Chat with her” 209 with user-generated message “Chat with her and give better replies” 200. As directed, chatbot system 108 responds to the predetermined unique identifier 202 and replaces output message “Chat with her” 209 with user-generated message “Chat with her and give better replies” 200 and then displays a crossed-out output message “Chat with her” 209 in output display 211 to indicate that message 209 is no longer valid.

Future input inquiries relating to “How to train my robot?” entered into dialog box 248 would generate the response “Chat with her and give better replies”. In this manner, merchant 106 can train chatbot system 108 to provide enhanced responses to input messages 210 from customers. The back and forth interaction between chatbot system 108 and merchant 106 via chatbot dialog interface 216 allows knowledge database 150 to store and modify myriad combinations of user-generated messages 200 as context for additional future chatbot messages.

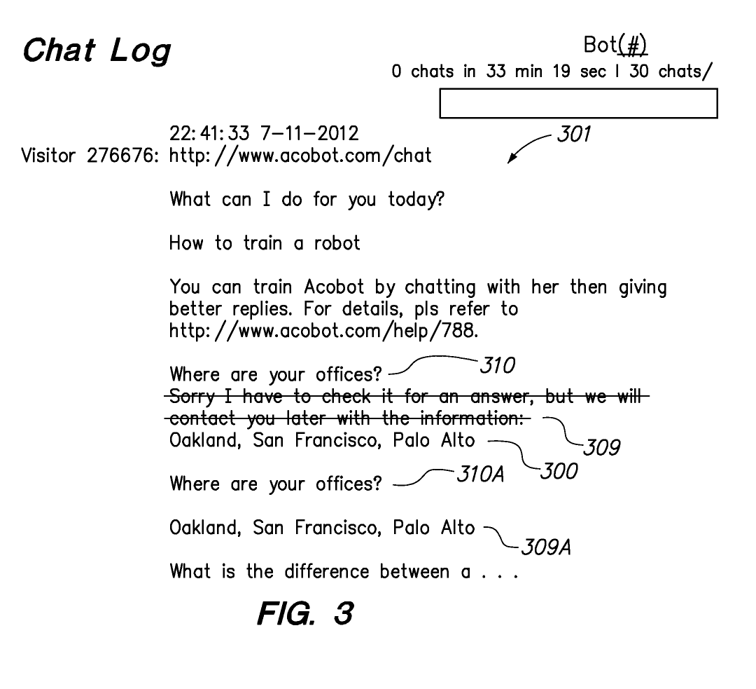

FIG. 3 illustrates training session 301 in accordance with an embodiment of the present invention.

In FIG. 3, merchant 106 trains chatbot system 108 to respond to various input messages or questions that can be asked by potential customers of user (merchant) 106. As shown, merchant 106 begins the training session by entering input message “Where are your offices?” 310. Those skilled in the art will recognize that this input message about the location of a business is commonly asked by users (e.g., user 102).

In response, chatbot system 108 provides chatbot message “Sorry, I have to check for an answer. But we will contact you later with the information” 309. Those skilled in the art, in light of the present teachings will recognize that most users 102 or 104 will not wait for a response. Rather, most users 102 or 104 would likely visit a different website.

Therefore, merchant 106 enters user-generated message “Oakland, San Francisco, Palo Alto” 300 to create a more specific chatbot message for future similar inquiries. Thus, when input message “Where are your offices?” 310A is submitted in the future, chatbot system 108 responds with output message “Oakland, San Francisco, Palo Alto” 309A.

In one embodiment of the present invention, after user-generated message 300 is entered, chatbot message “Sony, I have to check for an answer. But we will contact you later with the information” 309 is marked as obsolete by passing a line through, or surrounding the obsolete chatbot message with brackets. The displayed user-generated message 300 and the displayed chatbot message 309 marked as obsolete are displayed adjacent to each other for viewing by users.

In some embodiments, chatbot system 108 displays output message “Oakland, San Francisco, Palo Alto” 309A to respond to input message “Where are your offices?” 310A. Merchant 106 can further modify the chatbot message by including a street address and a phone number in subsequent user-generated messages.

The chatbot message can be further modified by using additional user-generated messages 300 for context. The training session then continues repetitively until merchant 106 achieves the desired chatbot output message 309. In this manner, chatbot message 309 is perpetually modified.

In FIG. 3, merchant 106 can also enter as many additional input messages and questions as well as corresponding user-generated responses for the input messages as desired by the user. In one alternative embodiment, a cookie may track user 102's geographic location and display a map that gives directions from user 102's geographic location to the office upon initiation by input message 210.

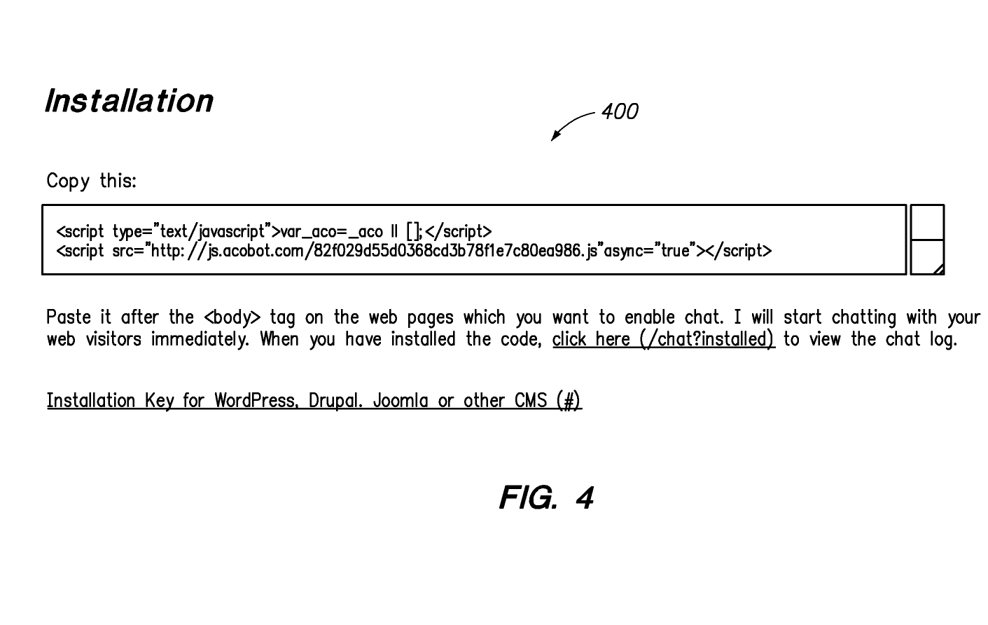

FIG. 4 illustrates embedded code 400 for installing chatbot system 108 onto a web site, in accordance with an exemplary embodiment of the present invention.

In FIG. 4, specifically, embedded code 400 is embedded into a desired webpage to install chatbot system 108, whereafter, chat sessions between merchant 106 and chatbot system 108 can occur. Those skilled in the art will recognize that the installation of chatbot system 108 and user-aided learning chatbot method 500 is efficacious for facilitated installation by a user. For example, merchant 106 might use without limitation the following:

Copy this:
<script type=“text/javascript”>var _aco = _aco || [ ]:</script>
<script src=“http://js.acobot.com/82f029d55d0368cd3b78f1e7c80ea986.js”
async=“true”></script>
Paste it after the <body> tag on the web pages which you want to
enable chat. I will start chatting with your web visitors immediately.
When you have installed the code, click here (/chat?installed) to view
the chat log.
Installation Key for WordPress, Drupal, Joomla or other CMS (#)

Here, the HTML script tag is used enable a JavaScript for client side scripting. Once installation is complete, merchant 106 can continue training chatbot system 108 to provide modified messages for each additional input message. Note that although not discussed, in one embodiment chatbot system 108 might be based on a Markov chain.

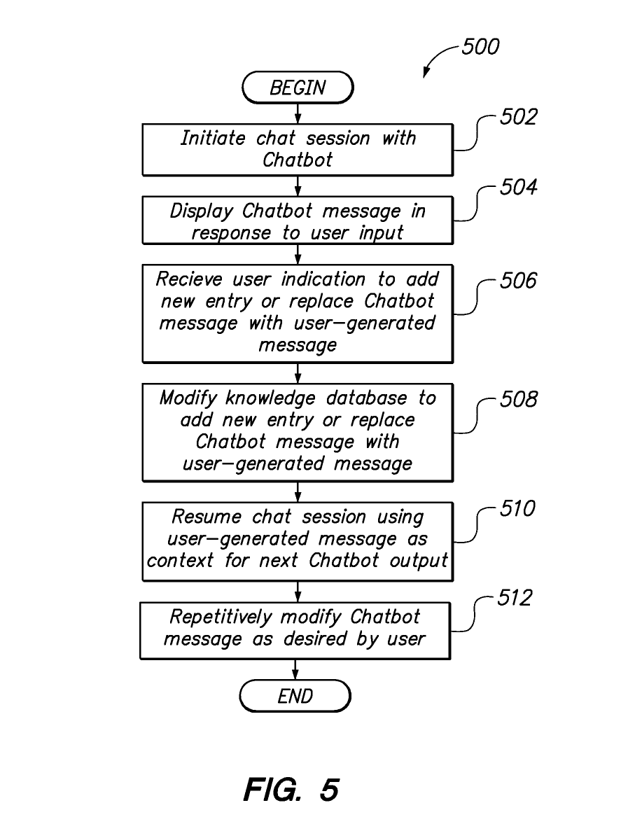

FIG. 5 illustrates user-aided learning chatbot method 500 in accordance with an embodiment of the present invention.

In FIG. 5, at block 502, chatbot method 500 involves initiating a chat session with chatbot system 108 (FIG. 1) when input message 210 (FIG. 2) is received from merchant 106 (FIG. 1) via chatbot dialog interface 216 (FIG. 2). Here, merchant 106 can include, without limitation, a merchant, a customer visiting a commercial website, a citizen visiting a government website, a participant in a social website. In some embodiments, chatbot system 108 includes a graphical image, including, without limitation, an avatar, a talking head, a text-to-speech engine, and a text box.

At block 504, chatbot method 500 then displays chatbot output message 209 (FIG. 2) as an output of chatbot system 108. Here, chatbot system 108 responds to input message 210 with chatbot message 209, which is merely a transitory response that can be edited by merchant 106 to provide a more robust, detailed message.

At block 506, indications are received from merchant 106 to replace chatbot message 209 with user-generated message 200. Such indications can be provided by user-generated message 200 via dialog box 248. Specifically, user-generated message 200 is preceded (and/or followed) by predetermined unique identifier 202, such as an asterisk or a slash bar that allows merchant 106 to indicate to chatbot system 108 to replace chatbot message 209 with user-generated message 200 or to add user-generated message 200 as a new entry.

In turn, chatbot system 108 then realizes that the message following and/or before the asterisk or slash bar is intended to replace chatbot message 209 or intended to add user-generated message 200 as a new entry. In this manner, merchant 106 trains chatbot system 108 to provide enhanced and modified responses from chatbot system 108 in response to user input messages 210.

Note that where a predetermined unique identifier 202 precedes the user-generated message and another predetermined unique identifier 202 follows the user-generated message, both predetermined unique identifiers can be either same, different or a combination of symbols. For example, >>This is an update<<. Here, right angled brackets>>and left angled brackets<<are predetermined unique identifiers. An another example, **This is an update<<may be used, or />This is an update<<might be employed.

The identifier can be either a symbol or a (normal) word or phrase. For example, BetterReply This is an update. Here, BetterReply is used as the predetermined unique identifier. As another example, Better Reply This is an update. Here, Better Reply is an identifier. As another example, BR This is an update. Here, BR is an identifier. Another example is Better This is an update. Here, Better is used as identifier. In other embodiments, the chosen identifier is one that is highly unlikely to be confused with the user-generated message.

At block 508, knowledge database 150 (FIG. 1) is modified to replace chatbot message 209 with user-generated message 200 so that input message 210 and user-generated message 200 are a paired entry in knowledge database 150. Note that input message 210 and user-generated message 200 need not be a paired entry in knowledge database 150. Where chatbot message 209 is created based on a set of rules and/or several paired entries in knowledge database 150, the knowledge database is modified to add user-generated message 200 as a new entry that is responsive to input message 210.

In the present embodiment, after user-generated message 200 is entered, chatbot system 108 determines whether user-generated message 200 is intended to be paired or associated with input message 210 by for example, identifying the predetermined unique identifier. In one embodiment, if the two messages are associated with each other, chatbot dialog interface 216 displays user-generated message 200 and chatbot message 209 adjacent to each other.

Those skilled in the art will recognize that user-generated message 200 is more robust and descriptive than the initial chatbot message 209. In one embodiment of the present invention, the pairing of input message 210 and user-generated message 200 is accomplished by scanning for keywords within input message 210 and user-generated message 200, and querying a response with the greatest number of matching keywords, or the most similar wording pattern, from a textual database, including knowledge database 150. Often, keywords or patterns are utilized to determine the association between the two messages.

Block 510 includes resuming the chat session by using user-generated message 200 of chatbot system 108 as context for subsequent chatbot messages. Each user-generated message 200 is stored in knowledge database 150, serving as a building block for present and future chat sessions. At block 510, user-generated message 200 can also be used as context for subsequent user input messages.

The most recent updated user-generated message 200 serves as a response to the prior input message 210, while simultaneously serving as a context for future chatbot messages 209. This contextual association produces an uninterrupted chat session, as user-generated message 200 is recorded and utilized by knowledge database 150 to perpetually enhance chatbot messages 209.

In another embodiment, the present invention creates a relationship between user-generated message (message 1, below) and a subsequent chatbot message (message 4, below) to produce a parent/child data structure such as follows:
User (Message 1): Are you a female bot?
Chat Bot (Message 2, a child of Message 1): Yes. Are you a girl?
User (Message 3, a child of Message 2): Yes.
Chat Bot (Message 4, a child of Message 3): How do you feel being a girl?

Unlike the prior art, the above patent/child data structure provides a consistent and simpler structure for editing entries while maintaining context.

In some embodiments, user-generated message 200 is used for updates without interrupting the chat session between merchant 106 and chatbot system 108. User-generated message 200 and prior input message 210 may be updated simultaneously.

Those skilled in the art, in light of the present teachings, will recognize that a set of scripts or an independent software program utilizes computer code efficacious for building chatbot system 108, nesting, and parent/child relationships between objects and classes to write the computer code for processor 140, knowledge database 150, and chatbot system 108, including, without limitation, Artificial Intelligence, Java AIML, HTML, Markov chains, and the like.

At block 512, chatbot method 500 involves repetitively modifying new chatbot messages 209 as desired by using a plurality of user-generated messages 200 and the predetermined unique identifiers 202. In this manner, chatbot system 108 logically interprets user-generated message 200 in proper context for continuing a chat session. The chat session can then proceed uninterrupted in a conversational chain, whereby user-generated messages 200 from merchant 106 are perpetually modifying chatbot messages 209 from chatbot system 108, while also serving as context for future merchant 106 input messages 210.

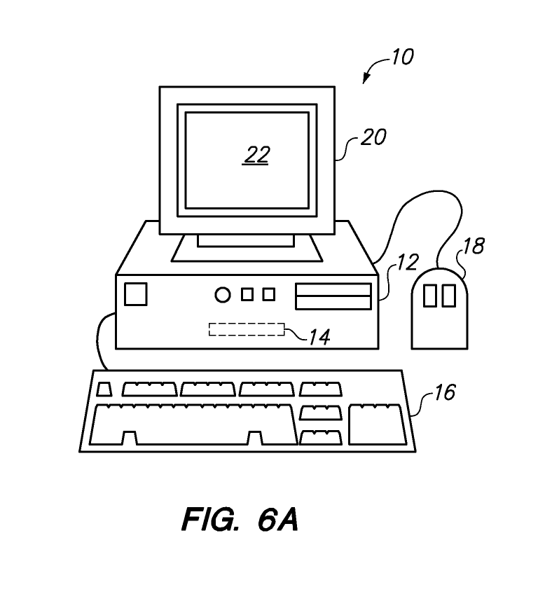

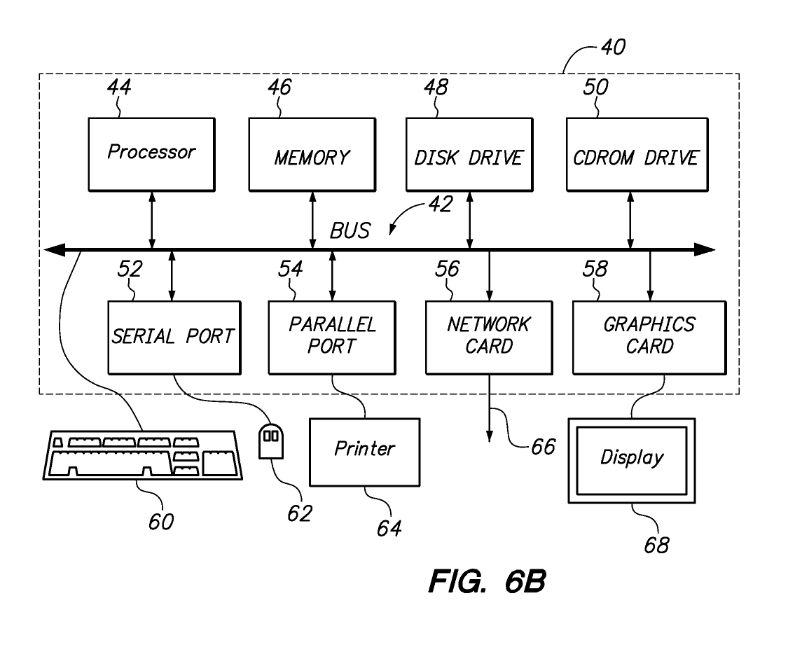

FIG. 6A shows a typical computer 10 such as would be operated by a user on the Internet. Computer 10 includes a cabinet 12 housing familiar computer components such as a processor, memory, disk drive, Compact Digital Read-Only Memory (CDROM), etc. (not shown). User input devices include keyboard 16 and mouse 18. Output devices include display 20 having a display screen 22. Naturally, many other configurations of a computer system are possible. Some computer systems may other components in addition to those shown in FIG. 6A while others will have fewer components. For example, server computers need not have attached input and output devices since they may only be accessed from time to time by other computers over a network. Human interaction with such a server computer can be at another computer that is equipped with input and output devices. Input and output devices exist in many variations from those shown in FIG. 6A. Displays can be liquid crystal displays (LCD), computer monitors, plasma, etc. Input devices can include a trackball, digitizing tablet, microphone, etc. In general, use of the term “input device” is intended to include all possible types of devices and ways to input information into a computer system or onto a network. Likewise the term “output device” includes all possible types of devices and ways to output information from a computer system to a human or to another machine.

The computer itself can be of varying types including laptop, notebook, palm-top, pen-top, etc. The computer may not resemble the computer of FIG. 6A as in the case where a processor is embedded into another device or appliance such as an automobile or a cellular telephone. Because of the ever-changing nature of computers and networks, the description of hardware in this specification is intended only by way of example for the purpose of illustrating the preferred embodiment. Any distributed networked system capable of executing programmed instructions is suitable for use with the present invention.

FIG. 6B shows subsystems of the computer of FIG. 6A. In FIG. 6B, subsystems within box 40 are internal to, for example, the cabinet 12 of FIG. 6A. Bus 42 is used to transfer information in the form of digital data between processor 44, memory 46, disk drive 48, CDROM drive 50, serial port 52, parallel port 54, network card 56 and graphics card 58. Many other subsystems may be included in an arbitrary computer system, and some of the subsystems shown in FIG. 6B may be omitted. External devices can connect to the computer system's bus (or another bus or line, not shown) to exchange information with the subsystems in box 40. For example, devices such as keyboard 60 can communicate with processor 44 via dedicated ports and drivers (shown symbolically as a direct connection to bus 42). Mouse 62 is connected to serial port 52. Devices such as printer 64 can connect through parallel port 54. Network card 56 can connect the computer system to a network. Display 68 is updated via graphics card 58. Again, many configurations of subsystems and external devices are possible.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A method, operable by a chatbot, for adding user entries to a knowledge database of the chatbot, wherein the chatbot includes a processor, an interactive dialog interface and a knowledge database, the method comprising:
initiating a chat session when an input message is received from a user via the interactive dialog interface and responsive to the input message;
displaying via the interactive dialog interface a chatbot message as an output of the chatbot, wherein the input message and the chatbot message are a paired entry in the knowledge database;
receiving indications from the user to replace the chatbot message with a user-generated message that is entered via the interactive dialog interface, wherein the user-generated message is preceded by a predetermined unique identifier, wherein the predetermined unique identifier directs the automated chatbot to replace the chatbot message with the user-generated message; and
modifying the knowledge database to replace the chatbot message with the user-generated message so that the input message and the user-generated message are a paired entry, wherein the user-generated message is displayed on the interactive dialog interface as the new output of the automatic chatbot.

2. The method of claim 1 further comprising
marking the displayed chatbot message as obsolete once the knowledge database is modified.

3. The method of claim 2 wherein the displayed chatbot message is marked obsolete by using deletion lines.

4. The method of claim 2 wherein the displayed chatbot message is marked obsolete by using brackets.

5. The method of claim 2 wherein the displayed user-generated message and the displayed chatbot message marked as obsolete are displayed adjacent to each other for viewing by the user.

6. The method of claim 1 wherein once the knowledge database is modified, the chatbot message is no longer displayed and is replaced in its entirety by the displayed user-generated message.

7. The method of claim 1 further comprising
resuming the chat session by using the user-generated message of the chatbot as context for the resulting chatbot message of the chatbot.

8. The method of claim 1 further comprising
resuming the chat session by using the user-generated message of the chatbot as context for the following user input message.

9. The method of claim 1 further comprising
repetitively modifying the new chatbot message as desired by using the predetermined unique identifier and a plurality of user-generated messages.

10. The method of claim 1 wherein the predetermined unique identifier is a symbol.

11. The method of claim 1 wherein the predetermined unique identifier is known before the chat session is initiated.

12. The method of claim 1, wherein the chatbot comprises a processor, the processor is operable to process the input message, the user-generated message, and the chatbot message, the chatbot further comprises a chat engine, the chat engine comprises a pattern matching portion, the pattern matching portion is operable to pair keywords, the chat engine further comprises a response generator, the response generator is operable to provide the chatbot message, the chat engine further comprises an input/output interface, the input/output interface being operable to receive and transmit the input message, the user-generated message, and the chatbot message.

13. A system, operable by a chatbot, for adding user entries to a knowledge database of the chatbot, the system being operable to use an interactive display and a computer system capable of processing one or more lines of code, the system comprising:
one or more lines of code instructions for initiating a chat session when an input message is received from a user via the interactive dialog interface and responsive to the input message;
one or more lines of code instructions for displaying via the interactive dialog interface a chatbot message as an output of the chatbot, wherein the input message and the chatbot message are a paired entry in the knowledge database;
one or more lines of code instructions for receiving indications from the user to replace the chatbot message with a user-generated message that is entered via the interactive dialog interface, wherein the user-generated message is preceded by a predetermined unique identifier, wherein the predetermined unique identifier directs the automated chatbot to replace the chatbot message with the user-generated message;
one or more lines of code instructions for modifying the knowledge database to replace the chatbot message with the user-generated message so that the input message and the user-generated message are a paired entry, wherein the user-generated message is displayed on the interactive dialog interface as the new output of the automatic chatbot;
one or more lines of code instructions for resuming the chat session by using the user-generated message of the chatbot as context for the following chatbot message of the chatbot;
one or more lines of code instructions for resuming the chat session by using the user-generated message of the chatbot as context for the following user input message; and
one or more lines of code instructions for repetitively modifying the new chatbot message as desired by using the predetermined unique identifier and a plurality of user-generated messages.

14. The method of claim 1 wherein the user-generated message is followed and not preceded by the predetermined unique identifier.

15. The method of claim 1 wherein the user-generated message is preceded and followed by the predetermined unique identifier.

16. The method of claim 15 wherein the preceding and the following predetermined unique identifiers are the same.

17. The method of claim 15 wherein the preceding and the following predetermined unique identifiers are the different.

18. The method of claim 1 wherein the predetermined unique identifier is a phrase.

19. A method, operable by a chatbot that includes a processor, an interactive dialog interface and a knowledge database, the method comprising:
initiating a chat session when an input message is received from a user via the interactive dialog interface and responsive to the input message;
displaying via the interactive dialog interface a chatbot message as an output of the chatbot, wherein the chatbot message is based on a set of rules;
receiving indications from the user to replace the chatbot message with a user-generated message that is entered via the interactive dialog interface, wherein the user-generated message is either preceded or followed by a predetermined unique identifier, wherein the predetermined unique identifier directs the automated chatbot to use the chatbot message in lieu of the user-generated message; and
modifying the knowledge database to add the user-generated message as a new entry so that responsive to receiving the input message, the user-generated message is displayed on the interactive dialog interface as the new output of the automatic chatbot.

20. The method of claim 19 wherein the user-generated message is preceded and followed by the predetermined unique identifier.
